(19) United States
(12) Patent Application Publication
(10) Pub. No.: US 2009/0266636 A1
(43) Pub. Date: Oct. 29, 2009

(54) Hybrid motorbike powered by muscle power and an electric motor with the current generated by a fuel cell

(76) Inventor: Hans Peter Naegeli, Affoltern (CH)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 12/455,424

(22) Filed: Jun. 1, 2009

Related U.S. Application Data
(63) Continuation-in-part of application No. 11/208,200, filed on Aug. 19, 2005, now abandoned.
(60) Provisional application No. 60/603,415, filed on Aug. 20, 2004.

(51) Int. Cl. B62M 23/02; B62M 11/14

(52) U.S. Cl. 180/205; 180/65.6

(57) ABSTRACT

A hybrid motorbike is provided which is powered by human muscle power on pedals and supplemented by an electric motor with the current generated by a fuel cell on the motorbike. The motorbike has a crown gear driven by muscle power, and a planetary-gear carrier with planetary gears transmitting power from a pulley connected to the motor by a belt to the ring gear of a bell attached to the crown gear which is attached to the drive wheel of the bike. The fuel cell and a battery and controls may be contained in an exchangeable module in the triangular space formed in the frame of the bike between the front wheel and seat. The bike has sensors to determine the speed and load placed on the pedals which is transmitted to a microprocessor programmed to control the electric motor according to the load on the pedals and the speed to provide the desired assistance to bike.

### CROSS-REFERENCE TO RELATED APPLICATION

This application is a continuation-in-part of U.S. patent application entitled, “Hybrid Motorbike Powered By Muscle Power And An Electric Motor With The Current Generated By A Fuel Cell,” having Ser. No. 11/208,200, filed Aug. 19, 2005, which claimed the benefit of U.S. provisional application entitled, “Hybrid Motorbike Powered by Muscle Power and an Electric Motor with the Current Generated by a Fuel Cell,” having Ser. No. 60/603,415, filed Aug. 20, 2004, which are entirely incorporated herein by reference.

### BACKGROUND OF THE INVENTION

### 1. Field of the Invention

This invention relates to a bicycle or motorbike which has a hybrid propulsion system of muscle power and an electric motor supplied with current generated by a fuel cell. The fuel cell and battery and controls may be contained in module that fits in the triangular space formed by the frame of the bicycle between the front wheel of the bicycle and the seat.

### SUMMARY OF THE INVENTION

This invention provides a fuel cell for producing electricity to drive an electric motor powering a drive wheel of a two wheel vehicle, such as a motorbike or bicycle. The fuel cell and battery and controls for controlling the fuel cell and the electric motor can be placed in a module in the triangular opening formed by the frame of the bicycle between the front wheel and the rider's seat. This allows for easy replacement of the fuel cells and battery. Fuel cells will supply current to the electric motor that drives the drive wheel and to the battery for storing electricity for future supply to the electric motor.

The combination of the fuel cell and battery to supply current for the electric motor can be used with any hybrid motorbike that has a mechanism for utilizing both muscle power and power supplied by an electric motor. It can be used with a planetary-gear train on the drive wheel.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a side elevation of a motorbike of this invention.

FIG. 2 is a rear view of the motorbike of FIG. 1 showing a part of the rear wheel and the fuel tank module for the fuel cell.

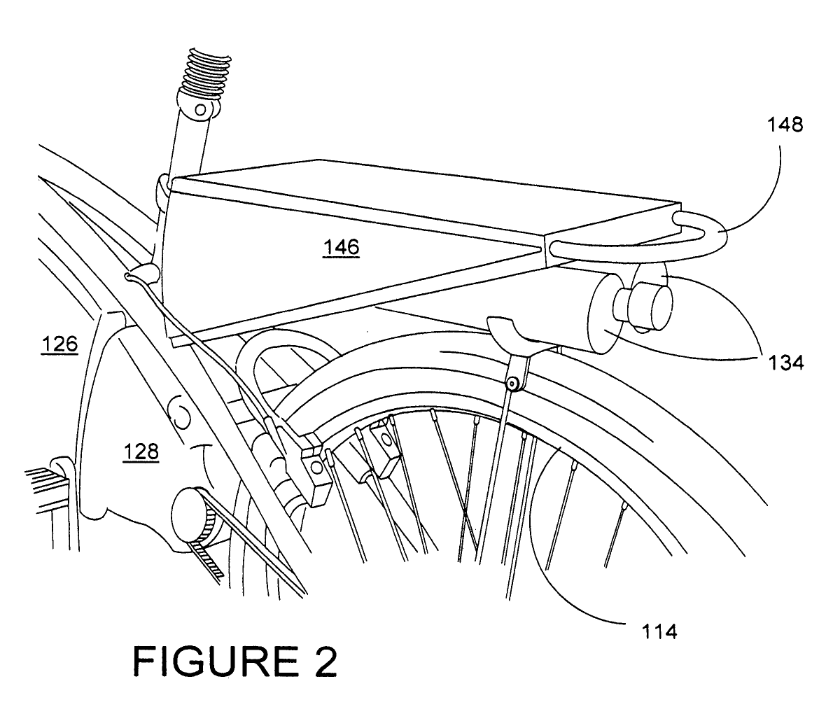

FIG. 3 is a side elevation of the middle of the motorbike of this invention with the cover removed from the power module on one side.

FIG. 4 is a top view of the electric motor used to partially power the motorbike of this invention.

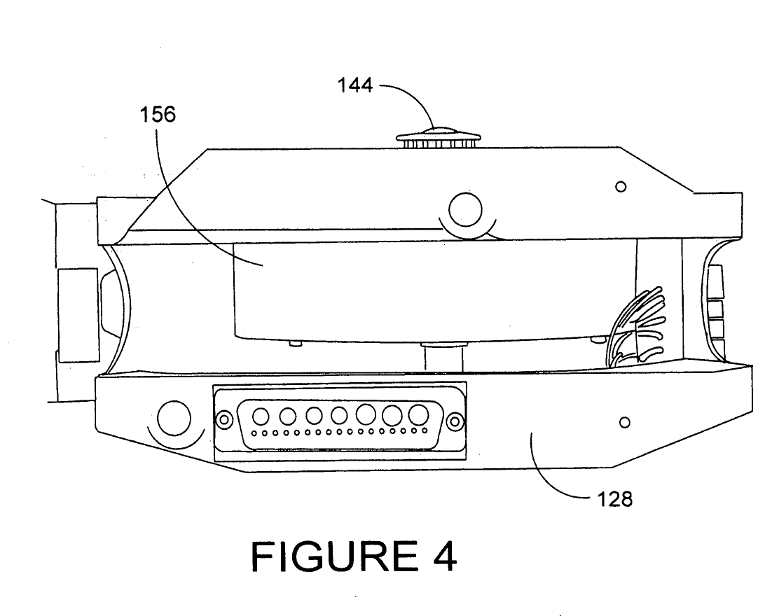

FIG. 5 is an exploded view of the planetary gear box used on the motorbike of this invention.

### DETAILED DESCRIPTION OF THE PREFERRED EMBODIMENT

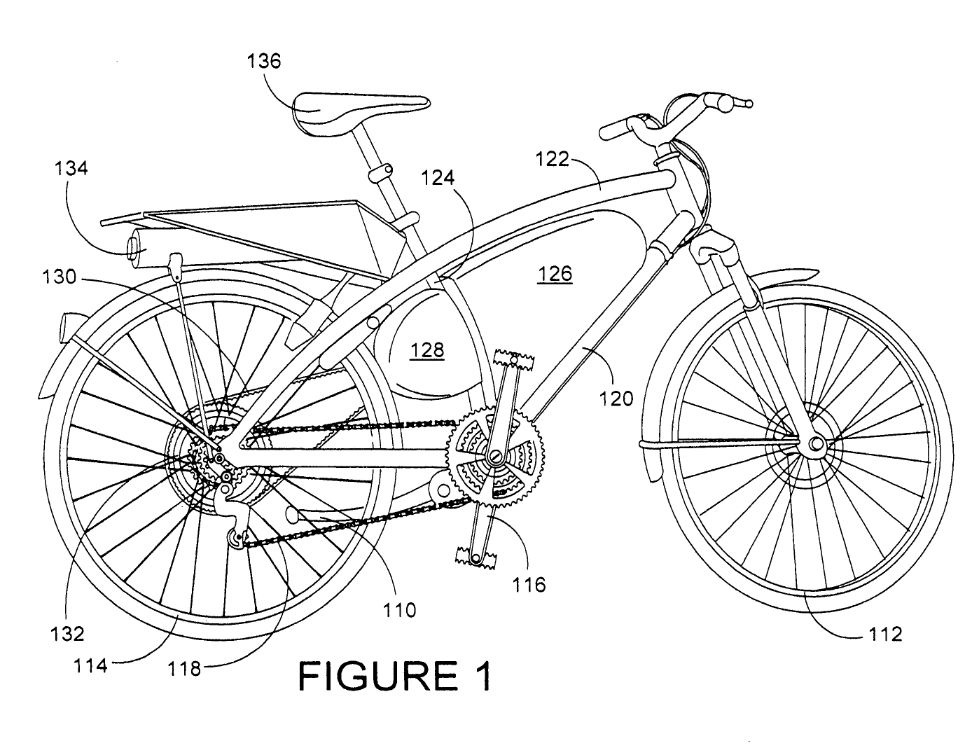

The embodiment shown in FIG. 1 shows a motorbike with a hybrid propulsion system. The hybrid motorbike 110 has a conventional frame and wheels with a front wheel 112, and a rear wheel 114 to which power is supplied. The motorbike has pedals 116 for supplying muscle power from the rider through a conventional gear on the pedal crank to which a pedal drive chain 118 is connected.

The frame of the bicycle has a bottom front fork 120 and a top front fork 122 which are supported and reinforced by a back connecting base 124. A power module 126 is supported in the triangular space formed by 120, 122, and 124. This power module 126 can be attached to the frame of the bicycle by any conventional means, such as bolts, which permit easy removal and installation. This bicycle has an electric motor 156 which is located immediately back of the back connecting base 124. A plastic motor drive belt 130 with teeth drives the rear wheel 114 of the motorbike. This motorbike has a seat 136 for the rider.

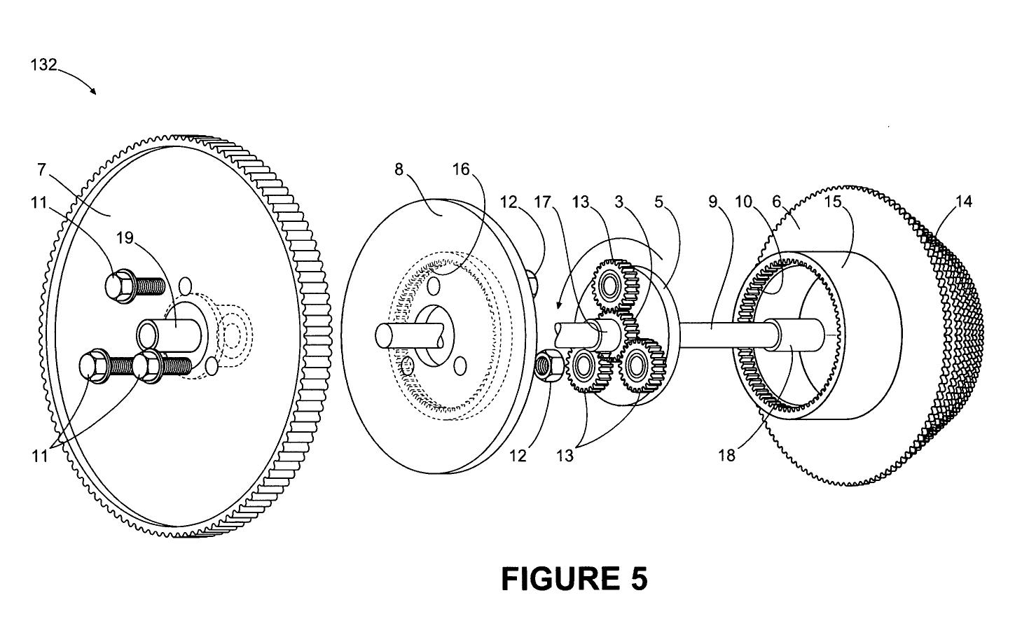

This motorbike 110 has a planetary-gear train 132 as shown in FIG. 5. It also has a crown gear (6) which is driven by the pedal drive chain 118. The motorbike may have a cluster of sprockets 14 attached to the crown gear 6 as a part of a variable-ratio transmission commonly known as a derailleur system. This system has a mechanism, such as a cable attached to a shift lever to move a chain guide from side to side, derailing the chain onto different sprockets. This derailleur system is used on many conventional multispeed conventional bicycles.

The motorbike has an axle or hub 9 to support the rear wheel 114, planetary-gear train 132, crown gear 6 and the sprocket cluster 14. The axle 9 has a central cylindrical bearing 17, a right end cylindrical bearing 18 and a left end cylindrical bearing 19 for the support of the planetary gear train 132, the crown gear 6 and sprockets 14 and pulley 7. A bell 15 is attached to the crown gear 6. The bell has a ring gear 10 about which the three planetary gears 13 are engaged on the right side of each planetary gear. The planetary gears 13 and sun gear 3 are attached to a planetary gear carrier 5 which fits inside the bell 15. The belt 130 from the electric motor 156 drives the pulley 7 which is attached by bolts 11 to hub flange 8, which has a ring gear 16 which engages the left side of each of the planetary gears 13. The sun gear 3 is free spinning around the axle 9. The planetary gears 13 drive the ring gear or annulus 10 of the bell 15 which applies power to the rear wheel 114. A hub flange 8 is attached by bolts 11 and nuts 12 to the pulley 7. The planetary-gear train 132 allows both the supply of muscle power and power from the electric motor to be used in a complementary fashion.

Muscle power turns the crank 116 with the chain 118 turning the crown gear 6 which is attached to the sprockets 14. This turns the attached rear wheel 114. When the muscle power is inadequate the electric motor 156 through belt 130 turns the pulley 7 which turns the interconnected hub flange 8. The ring gear 16 of the hub flange 8 applies power to the ring gear 10 of the bell 15 which supplements the muscle power in turning the rear wheel. Thus the planetary gears provides a loose coupling of the power supplied to the pulley 7 and the crown gear 6 to allow the motor to supplement the muscle power.

This motorbike 110 is partially powered by one or more fuel cells 150 which operate on hydrogen. The hydrogen fuel tanks 134 are supported in a fuel tank module 146 attached to the rear of the bike. This fuel tank module 146 has a handle 148 for easy removal for exchange for a new module. This module 146 includes two hydrogen fuel tanks 134.

The hydrogen fuel tanks can store the hydrogen in the form of hydrogen carbide, such as iron carbide, at relatively low pressure. These tanks 134 can be used to refuel from any convenient hydrogen source. It should be realized that high pressure hydrogen tanks may also be used.

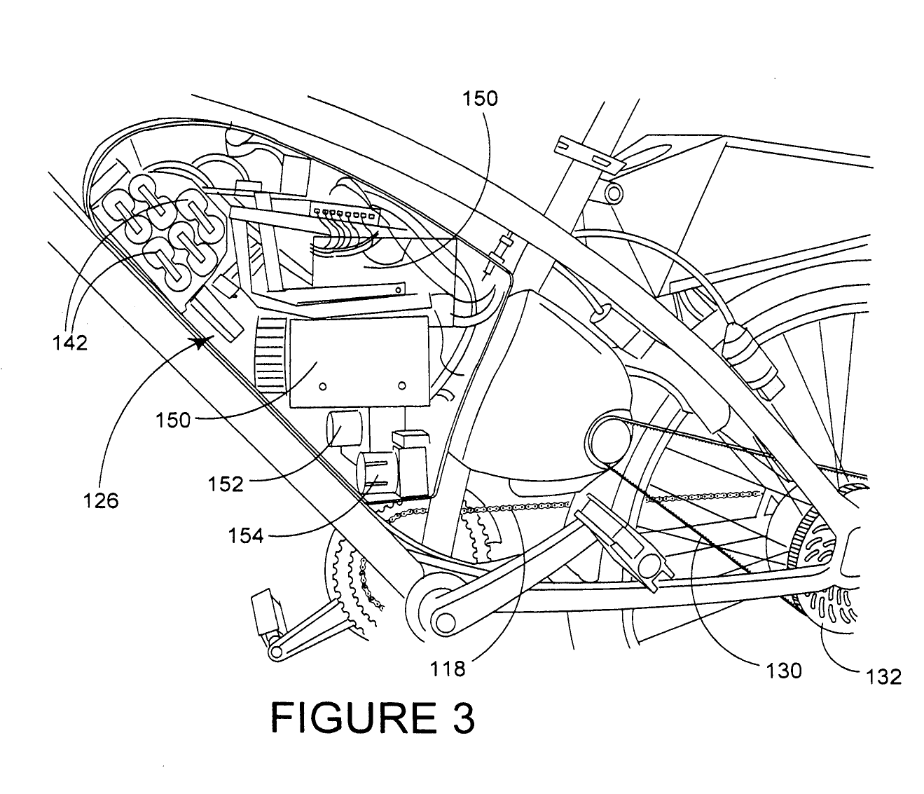

The power module 126 is shown in FIG. 3. It includes several batteries 142 and a stack of fuel cells 150 as shown in FIG. 3. There may be controls for starting and stopping the fuel cells 150. The power module 126 can also include controls for turning the electric motor on and off. The power module 126 can be attached to the back connecting base 124, top front fork 122 or the bottom front fork 120. When the battery or fuel cell expires or fails to operate, the entire module can be replaced. While the power module is the most convenient way to carry the fuel cells 150, it should be realized that the fuel cell or cells and the battery can be mounted on the bike without the use of a power module. The current produced by the fuel cells 150 is transmitted to the twenty-four volt electric motor 156 with any supplemental power used to charge the battery. A regulator, (not shown) can be used to control the distribution of current to the battery and to the electric motor 156 as desired. The electric motor 156 is encased in a case 128 which is attached to the frame of the bike. Controls can also be provided to automatically turn the fuel cells on and off in order to conserve fuel. This feature is not shown in the figures.

The fuel cells used in this invention use hydrogen from the hydrogen fuel tanks 134 and obtain oxygen from the air. The hydrogen can be pumped by pump 152 to the fuel cell. Air can be pumped to the fuel cells by air pump 154. The hydrogen and oxygen are combined in the fuel cell 142 to produce electricity with water vapor being the by-product. Since only water vapor is a by-product, no pollution of the atmosphere occurs in the use of this invention. While it is preferred that the fuel cell operate on hydrogen and oxygen, it should be realized that other types of fuel cells that produce electricity could be used as well. In the case of a fuel cell that uses hydrogen and oxygen, the oxygen is obtained from the atmosphere. Suitable wiring connects the electric controls the battery to the electric motor.

The electric motor 156 has a motor gear drive 144 to which the motor drive belt 130 is engaged. This electric motor can be a brushless DC motor or other type of DC motor. This invention is not limited to a DC motor as other types of motors can be utilized by converting the current from the fuel cell to AC.

This motorbike is extremely efficient in that testing of the motorbike has confirmed that only 45 grams of hydrogen is needed to assist in powering the motorbike a distance of 125 kilometers.

The battery, or batteries, 142 can be a nickel cadmium battery or a long lasting lithium battery.

It should be pointed out that because of the small amount of hydrogen that is used, it is possible to use a small hydrogen generating unit in the home or garage to generate the hydrogen to fill the tanks. The hydrogen could be generated by electrolysis of water. Alternatively, it could be generated by a reformer of a mixture of methanol and water.

The battery used in this motorbike can be a 12 or 24 volt battery.

The turning of the motor on and off or to regulate its speed to assist in powering the bike can be controlled by software that determines the load on the pedals and their rpm to either supply power from the electric motor or not and how much power to supply. This microcomputer can be housed in the power module or with the electric motor to use this software. A manual control can override the software in determining when the motor is turned on or off.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

Therefore, having thus described the invention, at least the following is claimed:

1. A two wheel motor vehicle powered by a hybrid power system consisting of an electric motor and muscle power supplied by a person comprising:
a vehicle frame supporting the front wheel and rear wheel and a seat, said frame forming an opening between the wheels for the placement and attachment to the frame of a power module;
a front axle supporting the front wheel;
a pedal crank for supplying muscle power with the crank being connected by a belt or chain to the rear wheel which has a variable speed transmission;
a rear axle supporting the rear wheel;
a power module, said module including a fuel cell for producing electricity from hydrogen and oxygen, and a battery;
a fuel tank for storing hydrogen for the fuel cell;
means for detachably attaching the power module to the frame;
and an electric motor for a least partially powering the rear wheel of the vehicle;
control means for controlling the power supplied by the electric motor to the rear wheel of the vehicle; and
said rear wheel having a planetary-gear train driven by the electric motor, a crown gear driven by muscle power, with the planetary-gear train providing mechanical power from the electric motor to the rear wheel in the amount determined by the control means

2. The two wheel motor vehicle of claim 1, in which the control means for controlling the speed of the electric motor is a microprocessor and sensors to determine the speed of and load placed on the pedals and transmit this information to the microprocessor which has been programmed to control the speed of the electric motor according to the load on the pedals and the speed of the pedals so as to provide the desired assistance of the electric motor in propelling the vehicle.

3. The two wheel vehicle of claim 2, in which the opening in the frame between the wheels is triangular in shape.

4. The two wheel vehicle of claim 3, in which the hydrogen is stored in the fuel tank as a hydrogen carbide.

5. The two wheel vehicle of claim 4, in which the carbide is an iron carbide.

6. The two wheel motor vehicle of claim 1, in which the mechanical power is mechanically transmitted by a person to the rear wheel of the vehicle being driven by pedals attached to a gear which is interconnected to a gear on the rear wheel being driven by a chain and a motor drive belt with teeth driven by a gear on the electric motor and interconnected to a pulley on the rear wheel of the vehicle

7. A multi-wheel motor vehicle powered by a hybrid power system consisting of an electric motor and muscle power supplied by a person comprising:
a vehicle frame supporting at least front wheel and one rear wheel with a connected crown gear and variable transmission, said frame supporting a seat, said frame forming an opening between the wheels for the placement and attachment to the frame of a power module;
a front axle supporting any front wheel;
a rear axle supporting the rear wheel, crown gear and variable transmission;
a pedal crank for supplying muscle power with the crank being connected by a belt or chain to the crown gear;
a power module, said module including a fuel cell for producing electricity from hydrogen and oxygen and a battery;
a fuel tank for storing hydrogen for the fuel cell;
means for detachably attaching the power module to the frame;
and an electric motor for a least partially powering the rear wheel of the vehicle;
the motor vehicle having a planetary-gear train with a plurality of planetary gears driven by the electric motor, a bell with an interior ring gear connected to the crown gear with the planetary-gears providing mechanical power from the electric motor to the interior ring gear of the bell; and
sensors to determine the speed of and load placed on the pedals and transmit this information to a microprocessor in the vehicle which has been programmed to control the speed of the electric motor according to the load on the pedals and the speed of the pedals so as to provide the desired assistance of the electric motor in propelling the vehicle.

8. The vehicle of claim 7, in which the hydrogen is stored in the fuel tank as a hydrogen carbide.

9. The vehicle of claim 7, in which the vehicle is a bicycle.

10. The vehicle of claim 7, which has a pulley supported by the rear axle, with a belt supplying power to the pulley from the electric motor, with the pulley affixed to a hub which has an interior ring gear enmeshed with the planetary gears which provide a power take-off to the drive wheel.

11. The vehicle of claim 10 in which the planetary gear train has a free spinning sun gear encircling the axle which supports the planetary gears which rotate around the sun gear in supplying power to the a ring gear of the bell.

12. The vehicle of claim 9, in which said opening between the wheels is triangular in shape defined by a top front fork, a bottom front fork and a back connecting base.

13. The vehicle of claim 7, in which the fuel cell is designed to produce electricity from hydrogen and oxygen with the oxygen obtained from the atmosphere and the hydrogen obtained from the fuel tank.

14. A two wheel motor vehicle powered by a hybrid power system consisting of an electric motor and muscle power supplied by a person comprising:
a vehicle frame supporting the front wheel and rear wheel with a connected crown gear and variable transmission, the frame supporting a seat and forming an opening between the wheels for the placement and attachment to the frame of a power module;
a front axle supporting the front wheel;
a rear axle supporting the rear wheel, crown gear with a bell with an interior ring gear, variable speed transmission and a planetary gear train;
a pedal crank for supplying muscle power with the crank being connected by a belt or chain to the crown gear;
a power module, said module including a fuel cell for producing electricity from hydrogen and oxygen, and a battery;
a fuel tank for storing hydrogen for the fuel cell;
means for detachably attaching the power module to the frame;
and an electric motor for a least partially powering the rear wheel of the vehicle;
said rear wheel having a pulley supported by the rear axle, with a belt supplying power to the pulley from the electric motor, with the pulley affixed to a hub which has an interior ring gear, with the planetary-gear train having a free spinning sun gear supported by the axle and planetary gears which rotate around the sun gear, with the planetary gears enmeshed with interior ring gear of the hub and the driven by the electric motor, with the planetary gears also being enmeshed with the interior ring gear of the bell; and
sensors to determine the speed of and load placed on the pedals and transmit this information to a microprocessor in the vehicle which has been programmed to control the speed of the electric motor according to the load on the pedals and the speed of the pedals so as to provide the desired assistance of the electric motor in propelling the vehicle.

15. The vehicle of claim 14 in which the variable speed transmission is a derailleur system.

16. The vehicle of claim 14 in which the planetary gear train has a cylindrical bearing between the axle and the sun gear.

17. The vehicle of claim 15 in which the planetary gear train has a cylindrical bearing between the axle and the sun gear and the pulley and crown gear have cylindrical bearings between the axle and pulley and crown gear respectively.
